(19) United States
(12) Patent Application Publication
(10) Pub. No.: US 2004/0116150 A1
(43) Pub. Date: Jun. 17, 2004

(54) Cordless wireless local loop phone

(76) Inventors: Satoru Yukie, San Diego, CA (US); Mike Kwon, San Diego, CA (US); Duk San Kim, San Diego, CA (US); Craig M. Hagopian, San Diego, CA (US)

Correspondence Address: FROMMER LAWRENCE & HAUG, 745 FIFTH AVENUE- 10TH FL., NEW YORK, NY, 10151, US

(21) Appl. No.: 10/660,127

(22) Filed: Sep. 10, 2003

Related U.S. Application Data
(60) Provisional application No. 60/409,721, filed on Sep. 10, 2002.
(60) Provisional application No. 60/409,719, filed on Sep. 10, 2002.

(51) Int. Cl. H04M 1/00; H04B 1/38

(52) U.S. Cl. 455/550.1; 455/556.1; 455/557

(57) ABSTRACT

Methods and apparatus for implementing a phone system providing a local wireless connection and a wide area wireless connection. In one implementation, a phone system includes: a terminal unit comprising: a first antenna, a first modem connected to said first antenna, a second antenna, a second modem connected to said second antenna, a modem interface connected to said first modem and to said second modem; wherein said first modem provides a first air interface using said first antenna for short range communication, said second modem provides a second air interface using said second antenna, and said second air interface is different than said first air interface.

This application claims the benefit of U.S. Provisional Application No. 60/409,721, filed Sep. 10, 2002, the disclosure of which is incorporated herein by reference.

### BACKGROUND

A wireless local loop phone is used to communicate with a wireless cellular or PCS network. Typically, a wireless local loop phone includes a handset connected to a terminal unit. The terminal unit provides an air interface to communicate with a wireless network, such as a CDMA, GSM, or TDMA network. Wireless local loop phones are often used as local and long distance home phones where a land line phone system is not available.

### SUMMARY

The present invention provides methods and apparatus for implementing a phone system providing a local wireless connection and a wide area wireless connection. In one implementation, a phone system includes: a terminal unit comprising: a first antenna, a first modem connected to said first antenna, a second antenna, a second modem connected to said second antenna, a modem interface connected to said first modem and to said second modem; wherein said first modem provides a first air interface using said first antenna for short range communication, said second modem provides a second air interface using said second antenna, and said second air interface is different than said first air interface.

In another implementation, a method of wireless communication includes: receiving a signal in a first air interface format from a wireless base station through a first antenna of a terminal unit; converting said signal to a second air interface format; and sending said signal in said second air interface format to a wireless handset through a second antenna of said terminal unit; wherein said first air interface format is a wireless local loop air interface format, said second air interface format is a short range wireless air interface format, and said signal includes voice data.

In another implementation, a method of wireless communication includes: receiving a signal in a first air interface format from a wireless handset through a first antenna of a terminal unit; converting said signal to a second air interface format; and sending said signal in said second air interface format to a wireless base station through a second antenna of said terminal unit; wherein said first air interface format is a short range wireless air interface format, said second air interface format is a wireless local loop air interface format, and said signal includes voice data.

In another implementation, a method of wireless communication includes: receiving a signal including a command in a first air interface format from a wireless handset through a first antenna of a terminal unit; converting said signal to command data indicating said command; and executing said command at said terminal unit; wherein said first air interface format is a short range wireless air interface format, said second air interface format is a wireless local loop air interface format, and said terminal unit includes a second antenna for supporting a second air interface.

### BRIEF DESCRIPTION OF THE DRAWINGS

FIG. 1 shows one implementation of a wireless local loop phone system.

FIG. 2 shows a block diagram of one implementation of a wireless local loop terminal unit.

FIG. 3 shows a block diagram of one implementation of a cordless handset.

FIG. 4 shows a flow chart of one implementation of sending voice data from a handset to a wireless network.

FIG. 5 shows a flow chart of one implementation of sending voice data from a wireless network to a handset.

FIG. 6 shows a flow chart of one implementation of issuing a command from a handset to a wireless local loop terminal unit.

### DETAILED DESCRIPTION

The present invention provides methods and apparatus for implementing a phone system providing a local wireless connection and a wide area wireless connection. In one implementation, a terminal unit provides a wireless local loop interface to communicate with a cellular or PCS network and a cordless telephone interface to communicate with a cordless handset. A user places and receives calls through the cordless handset. The terminal unit interacts with the cordless handset and the cellular network to act as a pass through or intermediary device between the cordless handset and the public switched telephone network (PSTN).

An illustrative example of one implementation is described below. Additional variations are described after this example.

In one example of one implementation, a wireless local loop terminal unit includes two modems: a CDMA modem and a cordless phone modem. The terminal unit also includes a modem interface connected to the modems. A cordless handset includes a cordless phone modem that is compatible with the cordless phone modem of the terminal unit.

A user speaks into a microphone in the cordless handset to send voice data, such as when speaking to another user in a phone conversation. The cordless handset processes the incoming audio, generating voice data. The cordless handset sends the voice data to the terminal unit through the cordless phone modem. The terminal unit receives the voice data through its cordless phone modem. The terminal unit uses the modem interface to process the voice data and pass the processed voice data to the CDMA modem. The terminal unit sends the voice data to a CDMA wireless network through the CDMA modem. The CDMA network passes the voice data to the PSTN.

For incoming voice data, the terminal unit receives voice data from the CDMA wireless network through the CDMA modem (e.g., for voice data from the PSTN). The terminal unit uses the modem interface to process the voice data and pass the processed voice data to the cordless phone modem. The terminal unit sends the voice data to the cordless handset through the cordless phone modem. The cordless handset receives the voice data through its cordless phone modem. The cordless handset processes the received voice data and outputs corresponding audio through a speaker.

In this example, a user can place and receive calls to and from the PSTN using a cordless phone interface and a wireless local loop interface. In this way, a user gains the benefit of mobility in the local environment through the cordless connection between the handset and the terminal unit. The user also gains the benefits of a wireless local loop connection between the terminal unit and the PSTN (e.g., avoiding the cost of installing and maintaining a land line connection between the terminal unit and the PSTN).

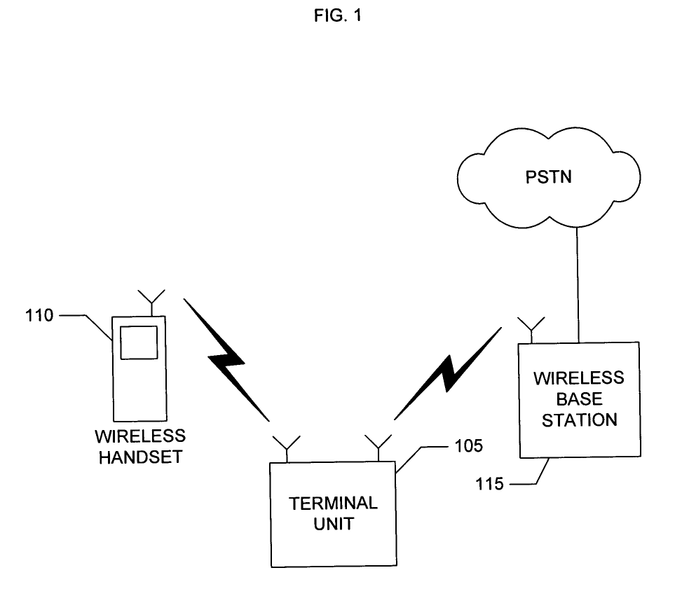

FIG. 1 shows one implementation of a wireless local loop phone system. A terminal unit 105 has a first wireless connection to a handset 110. The first wireless connection is a local wireless connection, such as a cordless phone connection or an IEEE 802.11 connection (“Wi-Fi”). The terminal unit 105 has a second wireless connection to a base station 115. The second wireless connection is a wide area wireless connection, such as a cellular, PCS, or fixed wireless connection. In one implementation, the wireless network is a dedicated wireless local loop network. In another implementation, the wireless network is a cellular or PCS network also used for wireless mobile handsets (e.g., cell phones). The base station 115 is connected to the public switched telephone network (PSTN). In another implementation, the base station is connected to a different telephone network such as a private exchange or private cellular network.

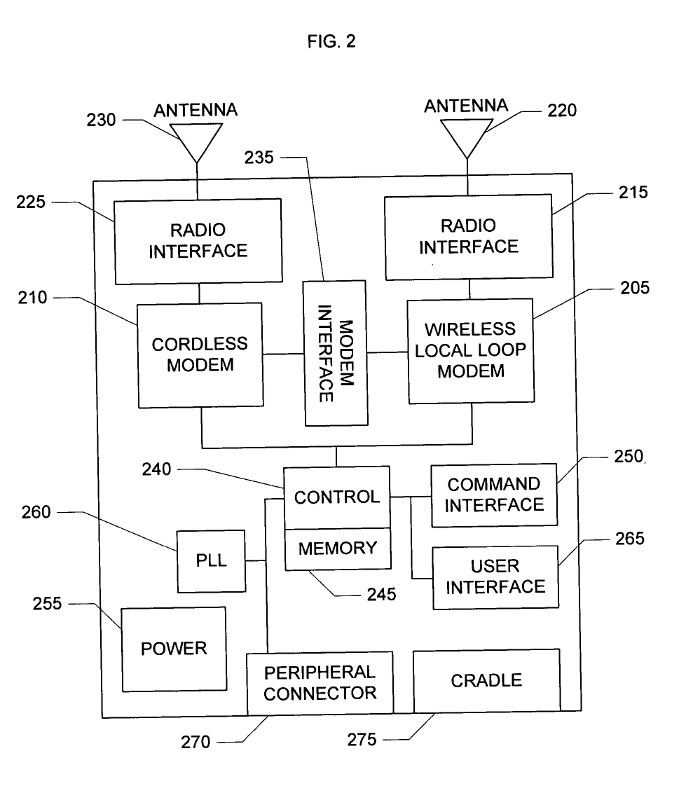

FIG. 2 shows a block diagram of one implementation of a wireless local loop terminal unit 200, such as for the terminal unit 105 shown in FIG. 1. The terminal unit 200 includes a wireless local loop (WLL) modem 205 and a cordless modem 210. The wireless local loop modem 205 is a wireless telephony modem and supports a wireless phone connection and protocol or air interface for communication with a wireless network, such as CDMA, TDMA, or GSM among others. The cordless modem 210 is another wireless telephony modem and supports a wireless phone connection and protocol or air interface for local or short-range communication with a wireless device or handset, such as a typical analog cordless connection, a digital cordless connection, or a wireless LAN connection (e.g., 802.11 or “Wi-Fi”).

The wireless local loop modem 205 is connected to a first radio interface 215 which is in turn connected to a first antenna 220. In one implementation, the radio interface 215 is a typical radio interface and includes: radio frequency (RF) components, a duplexer, a low noise amplifier (LNA), a bandpass filter (BPF), an isolator, and a power amplifier. The radio interface 215 operates similarly to typical radio interfaces in mobile wireless handsets. For sending signals using the wireless local loop connection, the wireless local loop modem 205 provides modulated signals to the radio interface 215. In the radio interface 215, the RF components provide the modulated signals from the wireless local loop modem 205 to the power amplifier. The power amplifier provides an amplified signal to the isolator, which in turn provides the signal to the duplexer and on to the antenna 220. For receiving signals using the wireless local loop connection, the antenna 220 provides a signal received from the wireless network to the duplexer. The duplexer provides the signal to the LNA which provides an amplified signal to the BPF. The BPF provides a filtered signal to the RF components which provide the signal to the wireless local loop modem 205.

The cordless modem 210 is connected to a second radio interface 225 which is in turn connected to a second antenna 230. The second radio interface 225 and antenna 230 operate similarly to the first radio interface 215 and antenna 220 to send and receive signals between the cordless modem 210 and a cordless handset (e.g., the cordless handset 110 shown in FIG. 1).

The wireless local loop modem 205 and the cordless modem 210 are both connected to a modem interface 235. The modem interface 235 processes and passes signals between the two modems 205, 210. The modem interface 235 provides any necessary conversion or formatting of signals and data to support passing data between the handset and the wireless network. For example, in one implementation, the modem interface 235 receives a demodulated signal from the cordless modem 210 and provides preprocessing of the signal to prepare the signal for the wireless local loop modem 205. In an alternative implementation, the wireless local loop modem and the cordless modem provide output data in the proper format for the other modem and so interact directly. In this case, the modem interface is omitted or integrated into the modems.

The terminal unit 200 includes a control block 240 and connected memory 245 to support and control the operation of the terminal unit 200. The control block 240 and the modems 205, 210 operate together to place and receive telephone calls through the wireless network. A command interface 250 is connected to the control block 240. The command interface 250 processes commands received by the terminal unit 200 for the handset and commands received from the handset for the terminal unit 200. The control block 240 and the command interface 250 operate in conjunction to carry out the received commands.

The terminal unit 200 also includes additional components typical of a wireless local loop terminal and a cordless phone terminal: a power source 255 (e.g., a battery or external power connection) connected to the powered components of the terminal unit 200 (connections not shown in FIG. 2); a phase locked loop (PLL) 260; a user interface 265 including a keypad (e.g., for number entry or a page button), ringer, and display; a peripheral interface 270 including one or more connections for external peripheral devices (e.g., RJ-11 to analog fax, RJ-11 to additional phones (cordless or wired), RJ-45/RS-232 to PC for data, or a network connection); and a cradle 275 for receiving the handset and providing power to the handset for recharging.

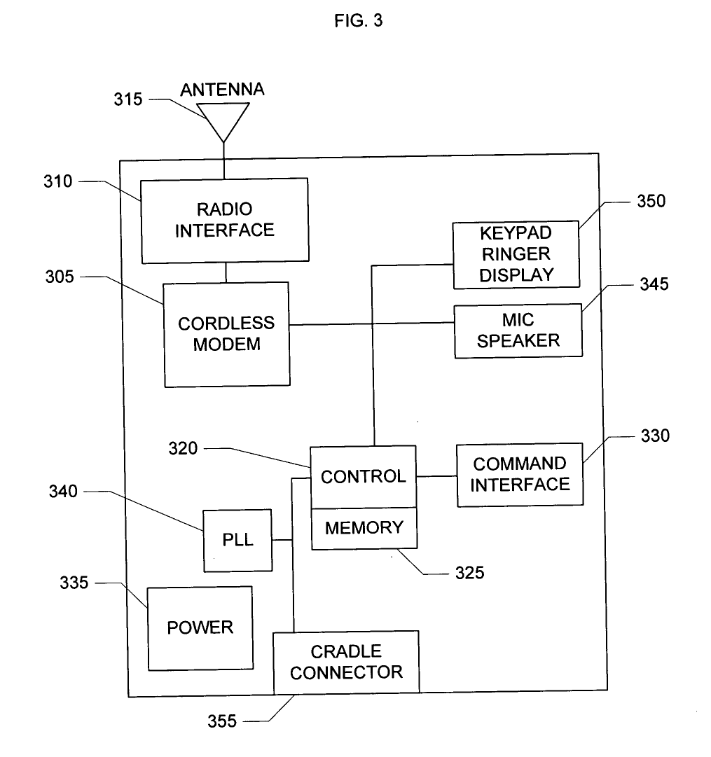

FIG. 3 shows a block diagram of one implementation of a cordless handset 300, such as for the handset 110 shown in FIG. 1. The handset 300 includes a cordless modem 305. The cordless modem 305 is a wireless telephony modem and supports a wireless phone connection and protocol or air interface for local or short-range communication with a wireless device or handset, such as a typical analog cordless connection, a digital cordless connection, for a wireless LAN connection (e.g., 802.11 or “Wi-Fi”). The cordless modem 305 is connected to a radio interface 310 which is in turn connected to an antenna 315. The radio interface 310 and antenna 315 operate similarly to the radio interface 225 and antenna 230 described above to send and receive signals between the cordless modem 305 and a cordless terminal unit (e.g., the terminal unit 105 shown in FIG. 1).

The handset 300 includes a control block 320 and connected memory 325 to support and control the operation of the handset. 300 The control block 320 and the modem 305 operate together to place and receive telephone calls through the terminal unit and the wireless network. A command interface 330 is connected to the control block 320. The command interface 330 processes commands received by the handset 300 for the terminal unit and commands received from the terminal unit for the handset 300. The control block 320 and the command interface 330 operate in conjunction to carry out the received commands.

The handset 300 also includes additional components typical of a cordless phone handset: a power source 335 (e.g., a rechargeable battery) connected to the powered components of the handset 300 (connections not shown in FIG. 3); a phase locked loop (PLL) 340; an audio block 345 including a microphone and a speaker; a user interface 350 including a keypad (e.g., for number entry), ringer, and display; and a cradle connector 355 for connecting the handset 300 to the terminal unit and providing power to the handset 300 for recharging.

The terminal unit and the handset operate together so that a user can originate and receive calls through the telephone network connected to the wireless local loop network of the terminal unit. For example, the handset and terminal unit provide basic wireless local loop phone functions such as a simulated dial tone function and an auto pulse sending function.

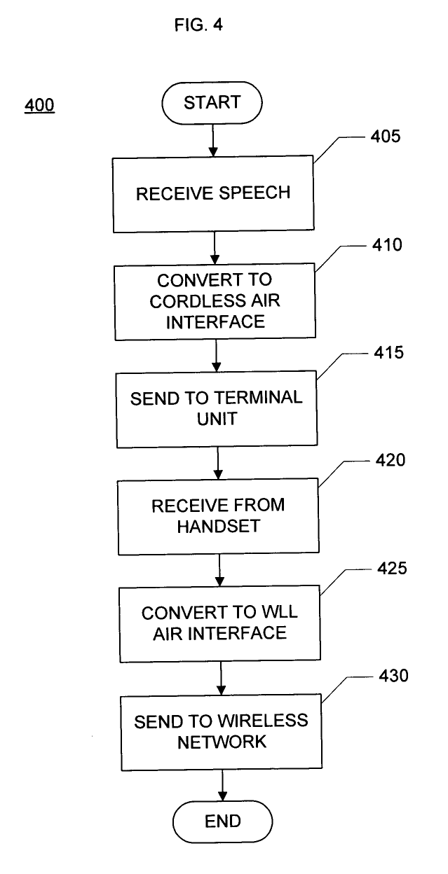

FIG. 4 shows a flow chart 400 of one implementation of sending voice data from a handset to a wireless network. Initially, a telephone call has been placed or received through the handset and terminal unit, establishing an open connection between the handset and the terminal unit and between the terminal unit and the wireless network.

A user speaks into a microphone of the handset, block 405. The handset processes the audio signal and converts the audio signal to a signal formatted for the air interface between the handset and the terminal unit, block 410. In one implementation, the handset processes and modulates the audio signal according to a typical cordless phone air interface. The handset sends the formatted signal to the terminal unit, block 415. The handset sends the formatted signal to the terminal unit using the cordless modem and antenna of the handset.

The terminal unit receives the signal from the handset, block 420. The terminal unit receives and processes the signal using the antenna and modem corresponding to the air interface between the handset and the terminal unit. The terminal unit converts the received signal to a signal formatted for the air interface between the terminal unit and the wireless network, block 425. In one implementation, the terminal unit uses a modem interface to pass the signal from the modem for the air interface corresponding to the handset to the modem for the air interface corresponding to the wireless network. The terminal unit processes and modulates the signal according to a wireless local loop air interface, such as a CDMA interface. The terminal unit sends the reformatted signal to the wireless network, block 430. The terminal unit sends the reformatted signal to a base station in the wireless network using the wireless local loop modem and antenna of the terminal unit.

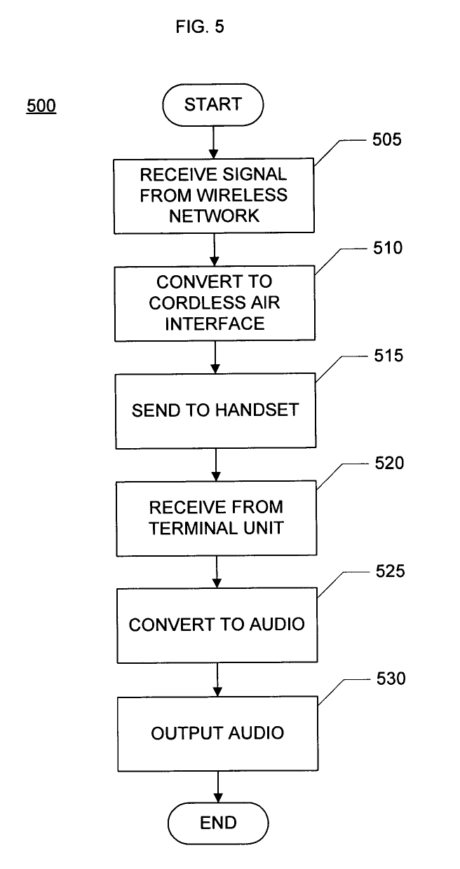

FIG. 5 shows a flow chart 500 of one implementation of sending voice data from a wireless network to a handset. Initially, a telephone call has been placed or received through the handset and terminal unit establishing an open connection between the handset and the terminal unit and between the terminal unit and the wireless network.

The terminal unit receives a signal including voice data from the wireless network, block 505. The terminal unit receives and processes a signal from a base station in the wireless network using the wireless local loop modem and antenna of the terminal unit. The terminal unit converts the received signal to a signal formatted for the air interface between the terminal unit and the handset, block 510. In one implementation, the terminal unit uses a modem interface to pass the signal from the modem for the air interface corresponding to the wireless network to the modem for the air interface corresponding to the handset. The terminal unit processes and modulates the signal according to a typical cordless phone air interface. The terminal unit sends the formatted signal to the handset, block 515. The terminal unit sends the signal to the handset using the cordless modem and antenna of the terminal unit.

The handset receives the signal from the terminal unit, block 520. The handset receives and processes the signal from the terminal unit using the modem and antenna of the handset. The handset processes the received signal and converts the signal to an audio signal, block 525. In one implementation, the handset processes in demodulates the signal according to a typical cordless phone air interface. The handset outputs the audio through a speaker to the user, block 530.

The terminal unit and handset also operate together to allow a user to enter commands to control the terminal unit through the handset and to control the handset through the terminal unit. As described above, in one implementation, each of the terminal unit and the handset include user interfaces for inputting commands and display information about the results of commands. In another implementation, either or both of the handset and the terminal unit include components for supporting and processing speech recognition for voice commands.

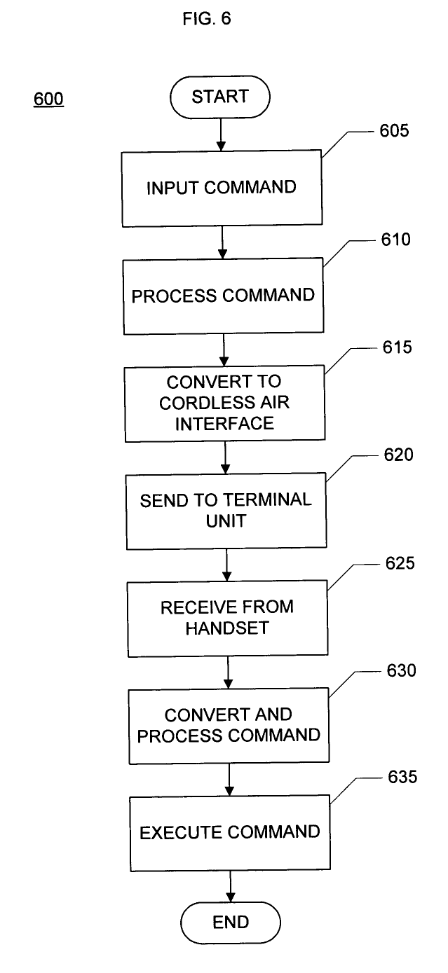

FIG. 6 shows a flow chart 600 of one implementation of issuing a command from a handset to a wireless local loop terminal unit. Initially, a user has activated a handset and opened a wireless connection between the handset and a terminal unit. The user inputs a command through the user interface of the handset, block 605. In one implementation, the user selects a command using a keypad on the handset. The handset processes the input command, block 610. The handset determines that the command is intended for the terminal unit rather than the handset. The handset uses a command interface to process and interpret the command. The handset converts the command to a signal formatted for the air interface between the handset and the terminal unit, block 615. In one implementation, the handset processes and modulates the command data according to a typical cordless phone air interface. The handset sends the formatted signal to the terminal unit, block 620. The handset sends the formatted signal to the terminal unit using the cordless modem and antenna of the handset.

The terminal unit receives the signal from the handset, block 625. The terminal unit receives the signal using the antenna and modem corresponding to the air interface between the handset and the terminal unit. The terminal unit converts the received signal to command data and processes the command, block 630. The terminal unit uses a command interface to process and interpret the command. The terminal unit executes the command, block 635.

A user can enter commands through the terminal unit to control the handset in a similar way. In this case, the terminal unit processes the input command and sends the command to the handset through the cordless air interface between the terminal unit and the handset. The handset in turn processes and executes the received command.

The various implementations of the invention are realized in electronic hardware, computer software, or combinations of these technologies. Some implementations include one or more computer programs executed by a programmable processor or computer. For example, referring to FIG. 1, in one implementation, the terminal unit 105 and the handset 110 include one or more programmable processors. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description focuses on implementations using a wireless local loop connection and a cordless phone connection, other connections can also be used, such as two cellular connections, or two wireless LAN connections. In another alternative implementation, either or both of the terminal unit and the handset are not a standalone units, but instead are components of other systems, such as integrated into a computer system (e.g., a laptop).

Accordingly, the present invention is not limited to only those implementations described above.

What is claimed is:

1. A phone system, comprising:
a terminal unit comprising:
a first antenna,
a first modem connected to said first antenna,
a second antenna,
a second modem connected to said second antenna,
a modem interface connected to said first modem and to said second modem;
wherein said first modem provides a first air interface using said first antenna for short range communication,
said second modem provides a second air interface using said second antenna, and
said second air interface is different than said first air interface.

2. The phone system of claim 1, wherein:
said modem interface provides signals from said first modem to said second modem and provides signals from said second modem to said first modem.

3. The phone system of claim 2, wherein:
said modem interface converts signals received from said first modem to first converted signals compatible with said second modem and provides said first converted signals to said second modem, and
said modem interface converts signals received from said second modem to second converted signals compatible with said first modem and provides said second converted signals to said first modem.

4. The phone system of claim 1, wherein:
said first air interface provides a cordless phone air interface.

5. The phone system of claim 1, wherein:
said second air interface provides a wireless local loop air interface.

6. The phone system of claim 1, wherein:
said second air interface provides a cellular phone air interface.

7. The phone system of claim 1, wherein:
said second air interface provides a PCS air interface.

8. The phone system of claim 1, further comprising:
a handset comprising:
a third antenna,
a third modem connected to said third antenna,
a handset user interface;
wherein said third modem provides a third air interface using said third antenna, and
said third air interface is the same as the first air interface such that the third modem can communicate with the first modem.

9. The phone system of claim 8, wherein:
said handset further comprises:
a handset command interface for processing commands received through said handset user interface.

10. The phone system of claim 9, wherein:
said handset command interface processes commands received from said terminal unit.

11. The phone system of claim 9, wherein:
said terminal unit further comprises:
a terminal command interface for processing commands received from said handset.

12. The phone system of claim 1, wherein:
said terminal unit further comprises:
a terminal user interface.

13. The phone system of claim 12, wherein:
said terminal unit further comprises:
a terminal command interface for processing commands received through said terminal user interface.

14. The phone system of claim 13, wherein:
said terminal command interface processes commands received from said handset.

15. A method of wireless communication, comprising:
receiving a signal in a first air interface format from a wireless base station through a first antenna of a terminal unit;
converting said signal to a second air interface format; and
sending said signal in said second air interface format to a wireless handset through a second antenna of said terminal unit;
wherein said first air interface format is a wireless local loop air interface format,
said second air interface format is a short range wireless air interface format, and
said signal includes voice data.

16. The method of claim 15, wherein:
said first air interface provides a cellular phone air interface.

17. The method of claim 15, wherein:
said first air interface provides a PCS air interface.

18. The method of claim 15, wherein:
said second air interface format is a cordless phone air interface format.

19. The method of claim 15, further comprising:
sending a command signal in said second air interface format from said terminal unit to said handset through said second antenna.

20. The method of claim 15, further comprising:
receiving a command signal in said second air interface format at said terminal unit from said handset through said second antenna.

21. A method of wireless communication, comprising:
receiving a signal in a first air interface format from a wireless handset through a first antenna of a terminal unit;
converting said signal to a second air interface format; and
sending said signal in said second air interface format to a wireless base station through a second antenna of said terminal unit;
wherein said first air interface format is a short range wireless air interface format,
said second air interface format is a wireless local loop air interface format, and
said signal includes voice data.

22. The method of claim 21, wherein:
said first air interface format is a cordless phone air interface format.

23. The method of claim 21, wherein:
said second air interface provides a cellular phone air interface.

24. The method of claim 21, wherein:
said second air interface provides a PCS air interface.

25. The method of claim 21, further comprising:
sending a command signal in said first air interface format from said terminal unit to said handset through said second antenna.

26. The method of claim 21, further comprising:
receiving a command signal in said first air interface format at said terminal unit from said handset through said second antenna.

27. A method of wireless communication, comprising:
receiving a signal including a command in a first air interface format from a wireless handset through a first antenna of a terminal unit;
converting said signal to command data indicating said command; and
executing said command at said terminal unit;
wherein said first air interface format is a short range wireless air interface format,
said second air interface format is a wireless local loop air interface format, and
said terminal unit includes a second antenna for supporting a second air interface.

28. The method of claim 27, wherein:
said first air interface format is a cordless phone air interface format.

29. The method of claim 27, wherein:
said second air interface provides a cellular phone air interface.

30. The method of claim 27, wherein:
said second air interface provides a PCS air interface.

31. The method of claim 27, wherein:
executing said command includes using said second air interface.

32. A system for wireless communication, comprising:
means for receiving a signal in a first air interface format from a wireless base station through a first antenna of a terminal unit;
means for converting said signal to a second air interface format; and
means for sending said signal in said second air interface format to a wireless handset through a second antenna of said terminal unit;
wherein said first air interface format is a wireless local loop air interface format,
said second air interface format is a short range wireless air interface format, and
said signal includes voice data.

33. The system of claim 32, wherein:
said first air interface provides a cellular phone air interface.

34. The system of claim 32, wherein:
said first air interface provides a PCS air interface.

35. The system of claim 32, wherein:
said second air interface format is a cordless phone air interface format.

36. The system of claim 32, further comprising:
means for sending a command signal in said second air interface format from said terminal unit to said handset through said second antenna.

37. The system of claim 32, further comprising:
means for receiving a command signal in said second air interface format at said terminal unit from said handset through said second antenna.

38. A system for wireless communication, comprising:
means for receiving a signal in a first air interface format from a wireless handset through a first antenna of a terminal unit;
means for converting said signal to a second air interface format; and
means for sending said signal in said second air interface format to a wireless base station through a second antenna of said terminal unit;
wherein said first air interface format is a short range wireless air interface format,
said second air interface format is a wireless local loop air interface format, and
said signal includes voice data.

39. The system of claim 38, wherein:
said first air interface format is a cordless phone air interface format.

40. The system of claim 38, wherein:
said second air interface provides a cellular phone air interface.

41. The system of claim 38, wherein:
said second air interface provides a PCS air interface.

42. The system of claim 38, further comprising:
means for sending a command signal in said first air interface format from said terminal unit to said handset through said second antenna.

43. The system of claim 38, further comprising:
means for receiving a command signal in said first air interface format at said terminal unit from said handset through said second antenna.

44. A system for wireless communication, comprising:
means for receiving a signal including a command in a first air interface format from a wireless handset through a first antenna of a terminal unit;
means for converting said signal to command data indicating said command; and
means for executing said command at said terminal unit using a second air interface;
wherein said first air interface format is a short range wireless air interface format, and
said second air interface format is a wireless local loop air interface format.

45. The system of claim 44, wherein:
said first air interface format is a cordless phone air interface format.

46. The system of claim 44, wherein:
said second air interface provides a cellular phone air interface.

47. The system of claim 44, wherein:
said second air interface provides a PCS air interface.
